(19) United States
(12) Patent Application Publication
(10) Pub. No.: US 2016/0189149 A1
(43) Pub. Date: Jun. 30, 2016

(54) BIOMETRIC SYSTEMS AND METHODS FOR AUTHENTICATION AND DETERMINATION OF GROUP CHARACTERISTICS

(71) Applicant: EBAY INC., San Jose, CA (US)

(72) Inventors: Matthew Bret MacLaurin, Santa Cruz, CA (US); Dane Glasgow, Los Altos, CA (US); David Ramadge, San Jose, CA (US); Bria Selhorst, Albany, CA (US)

(21) Appl. No.: 14/586,853

(22) Filed: Dec. 30, 2014

(51) Int. Cl. G06Q 20/40; G06K 9/00

(52) U.S. Cl. CPC G06Q 20/40; G06K 9/00892

(57) ABSTRACT

Systems and methods for authentication of users based on biometrics and determination of group characteristics based on biometrics are provided. Biometric profiles of users, which include reference biometric data for behavioral patterns and/or physiological characteristics, are stored in a biometric system. A biometric capture device captures a biometric sample that includes a representation of one or more biometrics of a user. The biometric system determines biometric data from the biometric sample and compares the biometric data with the reference biometric data. The biometric system may authenticate the user based on the comparison alone or in combination with other authentication techniques. Further, for biometric samples that include a representation of biometrics for a group of users, the biometric system may determine a group characteristic from the biometric sample and provide services relevant to the group.

### BACKGROUND

1. Field of the Invention

The present invention generally relates to biometrics and, more particularly, to using biometrics for authentication and/or payment, and for determining group characteristics.

2. Related Art

A biometric system may be used to authenticate users. For example, a user may scan a fingerprint on a fingerprint scanner on a mobile phone to unlock the mobile phone, or a user may scan a fingerprint on a fingerprint scanner at an entrance to an amusement park to enter the park. However, a user is typically required to train the biometric system, called “enrollment,” by providing biometric identifiers (e.g., a fingerprint) to be captured and stored by the biometric system, and the user is typically required to provide the biometric identifiers each time for authentication, which may be inconvenient to the user.

### BRIEF DESCRIPTION OF THE FIGURES

FIG. 1 is a block diagram illustrating an exemplary networked system according to an embodiment of the present disclosure;

FIG. 2 is a block diagram for an exemplary biometric profile database according to an embodiment of the present disclosure;

FIGS. 3A and 3B are top plan views of a physical merchant location with external biometric capture devices according to various embodiments of the present disclosure;

FIG. 4 is a flowchart showing an illustrative method for enrollment according to an embodiment of the present disclosure;

FIG. 5 is a flowchart showing an illustrative method for identifying users based on biometrics according to an embodiment of the present disclosure;

FIG. 6 is a flowchart showing an illustrative method for authenticating users based on biometrics according to an embodiment of the present disclosure;

FIG. 7 is a flowchart showing an illustrative method for determining group characteristics based on biometrics according to an embodiment of the present disclosure; and

FIG. 8 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides biometric systems and methods for authentication and determination of group characteristics.

In various embodiments, biometric profiles of users are stored in a biometric system. The biometric profiles include reference biometric data, which may be for one or more behavioral patterns and/or physiological characteristics. The biometric system may build a biometric profile of a user based on the user's actions and interactions with the environment. For example, the reference biometric data may be based on repetitive actions, such as how the user walks, types on a keyboard or a touchscreen, plays a video game (e.g., how the user moves a character in a video game), moves (e.g., how user side steps, jumps, etc.), drives, carries a user device (e.g., where user usually places his or her mobile phone), or other everyday activity.

In various embodiments, the biometric system receives a biometric sample for a user captured by a biometric capture device, which may be a user device (e.g., a mobile phone, smartphone, video game console, a notebook computer, a desktop personal computer, etc.) or a separate biometric capture device, such as an external biometric capture device located at a physical merchant location. The biometric sample may be an image, an image sequence, a fingerprint scan, a voice record, a movement record, or other sample captured by biometric capture device. The biometric samples may include a representation of behavioral patterns and/or physiological characteristics. Behavioral pattern biometrics may include, for example, gait, keystroke dynamics, gameplay dynamics, a signature, or a voice. Physiological characteristics biometrics may include, for example, a height, body proportions, infrared features, a heart rate, a fingerprint, or facial features.

In various embodiments, the biometric system determines biometric data from the biometric sample and compares the biometric data with the reference biometric data. The biometric system may authenticate the user based on the comparison alone or in combination with other authentication techniques (e.g., swiping a debit card and entering a personal identification number (PIN), swiping a credit card and providing a signature, using a user device to transmit a user identifier to a merchant device using near field communications, etc.).

In an example, an external biometric capture device at a point of sale (POS) of a physical merchant location captures an image sequence of a user while user approaches the POS. A biometric system receives the image sequence and determines biometric data including, for example, image-based gait data, height data, and facial feature data. The biometric system compares the biometric data with reference biometric data. The biometric system may authenticate the user based, at least in part, on the comparison, and authorize the user to make purchases. Accordingly, the biometric system advantageously provides improved security at the POS. If an unauthorized user tries to make a purchase using a credit card or a user device of another person, the biometric system will deny the purchase request because the biometric data of the unauthorized user does not match the reference biometric data of the owner of the credit card or the user device.

In another example, a user device captures a biometric sample for a user (e.g., which may represent gait based on motion sensing, a heart rate, a keystroke dynamic, and/or a gameplay dynamic). A biometric system receives the biometric sample and determines biometric data (e.g., motion-based gait data, heart rate data, keystroke dynamics data and/or gameplay dynamics data). The biometric system compares the biometric data with reference biometric data. When the user attempts to make a purchase using the user device, the biometric system authenticates the user for the purchase if the biometric data matches the reference biometric data of the owner of the user device.

In various embodiments, a biometric system may receive a biometric sample for users in a group (e.g., an image showing many users) from a biometric capture device. The biometric system may determine biometric data for each of the users, and the biometric data may be compared to reference biometric data. The biometric system may determine one or more characteristics of the group. For example, the group characteristics may relate to gender, age, emotional state (e.g., stress, urgency, relaxation, or other emotional state), condition (e.g., injury, sickness, etc.), or other group characteristics. The biometric system may then provide services relevant to the one or more group characteristics. For example, biometric system at a clothing store may determine that there are many women in their twenties, and may present advertisements or deals for clothing for young women. The biometric system may provide services further based on other information, such as a type of activity that users are performing, a location, a time of day, and/or environmental factors (e.g., light, temperature etc.). For example, biometric system may determine that a group of users are jogging during warm weather, and present an advertisement or a deal for a drink.

In an example, an external biometric capture device and a display panel may be at a physical merchant location. The external biometric capture device capture an image or image sequence of a group of users near the display panel. The biometric system receives the image or image sequence and determines biometric data for each of the users, and determines one or more group characteristics of the group of users. The biometric system may then select an advertisement relevant to that group and present the targeted advertisement on the display panel. Further, the biometric system may detect violence or a high level of stress based on the group characteristics, and notify the merchant or relevant authorities (e.g., police, law enforcement, security at the physical merchant location, etc.).

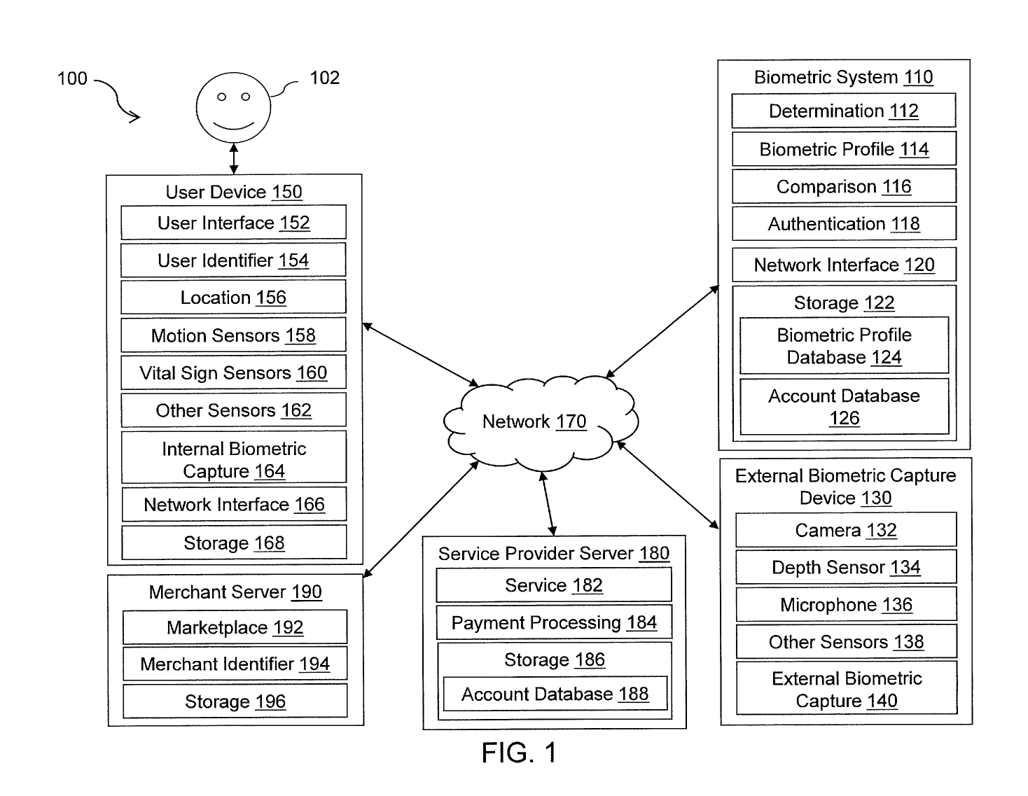

Referring now to FIG.1, an exemplary network-based system 100 for implementing one or more processes is described according to an embodiment of the present disclosure. As shown, network-based system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of networked system 100 illustrated in FIG. 1 includes a biometric system 110, one or more external biometric capture devices 130, one or more user devices 150 (e.g., a mobile phone, a smartphone, a wearable device, etc.) of one or more respective users 102, one or more service provider servers or devices 180 (e.g., network server devices), and one or more merchant servers or devices 190 in communication over network 170. Network 170, in one embodiment, may be implemented as a single network or a combination of multiple networks. For example, in various embodiments, network 170 may include the Internet and/or one or more intranets, landline networks, wireless networks, and/or other appropriate types of communication networks. In another example, network 170 may comprise a wireless telecommunications network (e.g., cellular phone network) adapted to communicate with other communication networks, such as the Internet. As such, in various embodiments, biometric system 110, user device 150, service provider server 180, and/or merchant server 190 may be associated with a particular link (e.g., a link, such as a URL (Uniform Resource Locator) to an IP (Internet Protocol) address).

Biometric system 110, in an embodiment, includes a biometric data determination module 112, a biometric profile module 114, a comparison module 116, an authentication module 118, a network interface module 120, and a storage module 122. Any or all of the modules may be implemented as a subsystem of biometric system 110 including a circuit, a hardware component, a hardware subcomponent, and/or a variety of other subsystems known in the art. Furthermore, any or all of the modules may be preconfigured to perform their disclosed functionality, or may be configured by a processing system “on-the-fly” or as needed to perform their disclosed functionality. As such, any or all of the modules may include pre-configured and dedicated circuits and/or hardware components, or may be circuits and/or hardware components that are configured as needed.

For example, any or all of the modules may be provided via one or more circuits that include resistors, inductors, capacitors, voltage sources, current sources, switches, logic gates, registers, and/or a variety of other circuit elements known in the art. One or more of the circuit elements in a circuit may be configured to provide the circuit(s) that cause the modules to perform the functions described below. As such, in some embodiments, preconfigured and dedicated circuits may be implemented to perform the functions of the modules. In other embodiments, a processing system may execute instructions on a non-transitory, computer-readable medium to configure one or more circuits as needed to perform the functions of the modules.

Biometric data determination module 112 may be included as a separate module provided in biometric system 110, or may be provided using instructions stored on a computer-readable medium that, when executed by a processing system in biometric system 110, configure biometric data determination module 112 to determine biometric data of user 102 from a biometric sample in response to receiving the biometric sample from a biometric capture device (e.g., user device 150 and/or external biometric capture device 130), as well as provide any of the other functionality that is discussed herein. In an embodiment, biometric data determination module 112 may include a feature extractor module configured to extract features from the biometric sample, and a template generator module may generate biometric data including a template using the extracted features (e.g., a gait template, a facial feature template, a fingerprint template, etc.). In another embodiment, biometric data determination module 112 may include a feature extractor module configured to extract features from the biometric sample, and a measurement module configured to measure certain features (e.g., a height, a body proportion, etc.).

Biometric profile module 114 may be included as a separate module provided in biometric system 110, or may be provided using instructions stored on a computer-readable medium that, when executed by a processing system in biometric system 110, configure biometric profile module 114 to build biometric profiles of users 102 by associating reference biometric data determined from biometric samples with corresponding users 102 in response to receiving the biometric samples from biometric capture devices (e.g., user device 150 and/or external biometric capture device 130), as well as provide any of the other functionality that is discussed herein. The reference biometric data may include biometric data for one or more types of behavioral patterns (e.g., gait data, typing dynamics data, gameplay dynamics data, signature data, voice data, etc.) and/or biometric data for one or more types of physiological characteristics (height data, facial feature data, body proportion data, heartbeat data, etc.).

Comparison module 116 may be included as a separate module provided in biometric system 110, or may be provided using instructions stored on a computer-readable medium that, when executed by a processing system in biometric system 110, configure comparison module 116 to compare the biometric data of user 102 with the reference biometric data, as well as provide any of the other functionality that is discussed herein. In an embodiment, comparison module 116 may include a matcher module configured to generate a matching score based on comparing the biometric data (e.g., a template) of user 102 with the reference biometric data (e.g., reference templates). In another embodiment, comparison module 116 may include a categorization module configured to determine a set to which the biometric data belongs by comparing the biometric data (e.g., a template) with reference biometric data categorized into sets (e.g., sets of reference templates). For example, a gait template of user 102 may be categorized into a set of gait templates based on foot strike (e.g., a set for forefoot strike gait templates, a set for midfoot strike gait templates, and a set for heel strike gait templates) or a set of gait templates based on gender (e.g., a set for female gait templates and a set for male gait templates).

Authentication module 118 may be included as a separate module provided in biometric system 110, or may be provided using instructions stored on a computer-readable medium that, when executed by a processing system in biometric system 110, configure authentication module 118 to authenticate user 102 based, at least in part, on the comparison between the biometric data of user 102 and the reference biometric data, as well as provide any of the other functionality that is discussed herein. Authentication module 118 may be configured to authenticate user 102 further based on user information received from a merchant device at the point of sale. The user information may be based on a user-entered personal identification number (PIN), a reading of a credit or debit card, a signature, a scanning of a barcode, and/or a near field communication between a user device and a merchant device.

Network interface module 120 is communicatively coupled to network 170, and may be communicatively coupled to any or all of modules 112, 114, 116, and/or 118, any of which may be coupled to a storage module 122. Network interface module 120 may be included as a separate module provided in biometric system 110, or may include communications hardware (e.g., antennas) and instructions stored on a computer-readable medium that, when executed by a processing system in biometric system 110, configure network interface module 120 to operate the communications hardware to send and receive data and/or information over network 170, as well as provide any of the other functionality that is discussed herein. Storage module 122 may include one or more databases, such as a biometric profile database 124 containing biometric profiles of users (e.g., biometric data of one or more types, association of biometric data with users, etc.) and/or an account database 126 containing account information (e.g., personal information, banking information, financial information, funding source information, etc.). Biometric profiles of each user may be associated with account information of each user. While storage module 122 has been illustrated as located in biometric system 110, one of skill in the art will recognize that it may include multiple storage modules and may be connected to other modules through network 170 without departing from the scope of the present disclosure. Other modules discussed herein but not illustrated in FIG. 1 may be provided as separate modules on biometric system 110, or using instructions stored on a computer-readable medium similarly as discussed above.

Biometric system 110, in various embodiments, may be a separate hardware server or device or may be provided in external biometric capture device 130, user device 150, service provider server 180, and/or merchant server 190.

External biometric capture device 130, in an embodiment, includes one or more cameras 132, a depth sensor 134, a microphone 136, other sensors 138, and an external biometric capture module 140. One or more cameras 132 may include a visible image camera configured to capture a visible light image and/or a visible light image sequence. One or more cameras 132 may also include an infrared image sensor configured to capture an infrared image and/or an infrared image sequence. Depth sensor 134 is configured to capture three-dimensional depth data, separately or together with camera 132. Depth sensor 134 may include an infrared light projector (e.g., infrared laser projector) and an image sensor configured to capture reflected infrared light to capture the depth data. Microphone 136 may be a single microphone or a microphone array configured to capture sound data and/or extract voice input from ambient noise. External biometric capture device 130 may include other sensors 138 configured to capture other data, such as a fingerprint scanner, a face recognition camera, a retinal scanner, and/or a signature pad.

External biometric capture module 140, in an embodiment, may operate sensors 132, 134, 136, and 138 to capture data and/or process the captured data to generate a biometric sample including the processed data. For example, external biometric capture module 140 may remove artifacts due to sensors 132, 134, 136, and 138 from the captured data, enhance the captured data, such as by removing background noise from the captured data and/or normalizing the captured data, and/or format the captured data. External biometric capture module 140 may then transmit the biometric sample to biometric system 110.

User device 150, in various embodiments, may be utilized by user 102 to interact with biometric system 110 over network 170. User device 150 may also be utilized by user 102 to interact with service provider server 180 and/or merchant server 190 over network 170. User device 150 may be implemented using any appropriate combination of hardware and/or software configured for wired and/or wireless communication over network 170. In various embodiments, user devices 150 may include at least one of a smartphone, wireless cellular phone, satellite phone, tablet, laptop computer, notebook computer, hybrid/convertible computer, a desktop personal computer, a gaming device (e.g., a video game console), and/or other types of computing devices. In other embodiments, user devices 150 may include at least one of a wearable device, such as an activity tracker (e.g., a fitness tracker, a health tracker, etc.), smart watch, eyeglasses with appropriate computer hardware resources, and/or other types of wearable computing devices. User devices 150 may include a user interface module 152, one or more user identifiers 154, a location module 156, a motion sensor module 158, a vital sign sensor module 160, other sensor modules 162, an internal biometric capture module 164, a network interface module 166, and a storage module 168.

In various implementations, user 102 is able to input data and information into an input component (e.g., a touchscreen, a keyboard, a microphone, a video game console controller, etc.) of user device 150 to provide personal information, user interest information, user identification information, and other user data and/or information.

User interface module 152, in an embodiment, may be utilized by user 102 to access applications, to view data or information on a display of user device 150, and to conduct transactions (e.g., shopping, purchasing, bidding, etc.) with biometric system 110, service provider server 180, and/or merchant server 190 over network 170. In one aspect, user 102 may login to an account associated with user 102, and purchase expenses may be directly and/or automatically debited from the account via user interface module 152.

In one implementation, user interface module 152 includes a software program, such as a graphical user interface (GUI), executable by a processor that is configured to interface and communicate with service provider server 180 via network 170. In another implementation, user interface module 152 comprises a browser module that provides a network interface to browse information available over network 170. For example, user interface module 152 may be implemented, in part, as a web browser to view information available over network 170.

In an example, user 102 is able to access merchant websites via one or more merchant servers 190 to view and select items for purchase, and the user 102 is able to purchase items from one or more merchant servers 190 via service provider server 180. Accordingly, in one or more embodiments, user 102 may conduct transactions (e.g., purchase and provide payment for one or more items) from one or more merchant servers 190 via service provider server 180.

One or more user identifiers 154, in an embodiment, may be implemented, for example, as operating system registry entries, cookies associated with user interface module 152, identifiers associated with hardware of user device 150, or various other appropriate identifiers. User identifier 154 may include one or more attributes related to user 102, such as personal information related to user 102 (e.g., one or more of names, user names, passwords, photograph images, biometric IDs, addresses, phone numbers, a social security number, etc.), banking information, financial information, and/or funding source information (e.g., one or more banking institutions, credit card issuers, user account numbers, security data and information, etc.). In various embodiments, identifier data that includes user identifier 154 may be transmitted with a user login request (e.g., user login data) to service provider server 180 via network 170, and service provider server 180 may use the identifier data to associate user 102 with a particular user account maintained by service provider server 180. In other embodiments, identifier data that includes user identifier 154 may be transmitted from user device 150 to biometric system 110 via network.

Location module 156, in an embodiment, determines, tracks, monitors, and/or provides an instant geographical location of user device 150. In one implementation, the geographical location may include GPS coordinates, zip-code information, area-code information, street address information, and/or various other generally known types of location data or information. In various embodiments, location data may be automatically obtained and/or provided by user device 150 via an internal or external monitoring component, such as global positioning system (GPS), which uses satellite-based positioning, assisted GPS (A-GPS), which uses cell tower information to improve reliability and accuracy of GPS-based positioning, and Wi-Fi-based positioning. In other embodiments, location data may be obtained based on communications between user device 150 and a device at a location, such as a check-in device (e.g., a beacon device). This may help to save battery life and allow for better indoor location. In further embodiments, location information may be directly entered into user device 150 by user 102 via a user input component, such as a keyboard, touch display, and/or voice recognition microphone.

Motion sensors 158, in an embodiment, may include an accelerometer configured to measure acceleration, a gyroscope configured to measure orientation, and/or other motion sensors. Motion sensors 158 may measure movement and orientation of user device 150. Based on the measured movement and orientation, motion sensor 158 may capture data representing a gait of user 102, walking pace, and/or an activity pattern of user 102. The data may represent gait for walking, walking while pushing a shopping cart, walking with a shopping basket, walking with a handbag, walking while wearing certain shoes (e.g., heels, flats, running shoes, dress shoes, slippers, etc.), jogging, running, etc.

Vital sign sensors 160, in an embodiment, may include a heart rate monitor configured to measure a heart rate, a blood pressure monitor configured to measure a blood pressure, a thermometer configured to measure a temperature, a respiratory monitor configured to measure a respiratory rate of user 102, and/or a blood oxygen monitor configured to measure blood oxygen. Any or all of the vital signs may be used as biometrics of user 102. Vital sign sensors 160 may capture and/or monitor such vital sign data.

User device 150 may include other sensors 162 configured to capture biometric data, such as a camera, a microphone, and/or a fingerprint scanner. The camera may be configured to capture image data and/or video data, and may be used to capture a biometric of user 102. For example, the camera may be used to capture a face of user 102, which may be used for face recognition. The microphone may be used to capture voice data, which may be used for voice recognition. The fingerprint scanner may be configured to capture a scan of a finger of user 102, which may be used for fingerprint recognition.

Internal biometric capture module 164, in an embodiment, may operate sensors 158, 160, and 162 to capture data and/or process the captured data to generate a biometric sample including the processed data. For example, internal biometric capture module 164 may remove artifacts due to sensors 158, 160, and 162 from the captured data, enhance the captured data, such as by removing background noise from the captured data and/or normalizing the captured data, and/or format the captured data. Internal biometric capture module 164 may then transmit the biometric sample to biometric system 110.

Network interface module 166, in an embodiment, communicates with other devices or servers over network 170. For example, user device 150 may communicate with biometric system 110, service provider server 180, and merchant server 190 via network interface module 166 exchanging data with a network interface module of respective devices or servers over network 170.

Storage module 168, in an embodiment, may store data and information. Storage module 168 may contain one or more databases in which to store the data and information. User device 150 may locally store user account information, sensor data, and/or biometric data (e.g., biometric samples) in a database on storage module 168.

In one aspect, when interfacing with user device 150, user 102 may elect and/or consent to provide biometric data (e.g., biometric samples), personal information, user interest data, sensor data, location data, and/or other user data or information to service provider server 180 and/or merchant server 190. User 102 may set or configure the user settings/configuration menu of user interface module 152 of user device 150. Through the user settings/configuration menu, user 102 may provide consent to share user data or information and the extent of shared user data or information. User device 150 may transmit shared user data or information dynamically by push synchronization, periodically, or each time an application associated with service provider server 180 or merchant server 190 is opened by user 102. In some embodiments, user 102 may be prompted for permission to release user data or information. Accordingly, user 102 may have exclusive authority to allow transmission of biometric data (e.g., biometric samples), personal information, user interest data, sensor data, and/or location data from user device 150 to service provider server 180 and/or merchant server 190.

User device 150, in an embodiment, may include other modules as may be desired in one or more embodiments of the present disclosure to provide additional features available to user 102. In one example, such other modules may include security modules for implementing client-side security features, programmatic client applications for interfacing with appropriate application programming interfaces (APIs) over network 170, and/or various other types of generally known programs and/or software modules. In still other examples, the other modules may interface with user interface module 152 for improved efficiency and convenience.

Service provider server 180, in one embodiment, may be maintained by a service provider, such as an online service provider or a transaction processing entity that provides processing for financial transactions and/or information transactions between user 102 and one or more of merchant servers 190. As such, service provider server 180 includes a service module 182, which may be adapted to interact with user device 150 over network 170 to facilitate the searching, selection, purchase, and/or payment of items by user 102 from one or more merchant servers 190. In one example, service provider server 180 may be provided by PayPal® Inc. or eBay® Inc. in San Jose, Calif., USA, and/or one or more financial institutions or a respective intermediary that may provide multiple point of sale devices at various locations to facilitate transaction routings between merchants and, for example, financial institutions.

Service module 182, in one embodiment, utilizes a payment processing module 184 to process purchases and/or payments for financial transactions between user 102 and each of merchant servers 190. In one implementation, payment processing module 184 assists with resolving financial transactions through validation, delivery, and settlement. As such, service module 182 in conjunction with the payment processing module 184 settles indebtedness between user 102 and each of merchant servers 190, wherein accounts may be directly and/or automatically debited and/or credited of monetary funds in a manner as accepted by the banking industry.

Service module 182, in an embodiment, may be configured to determine one or more characteristics of a group of users 102 and provide services relevant to the one or more characteristics. For example, the characteristics may include a proportion of each gender, an age distribution, and/or an emotional state distribution of the group. In an example, service module 182 may determine an advertisement based on the one or more characteristics and transmit the advertisement to a display panel located in the vicinity of the group to be presented to the group. In another example, service module 182 may transmit a notification to a merchant or relevant authority in response to the emotional state distribution indicating violence or a high level of stress.

Service provider server 180, in one embodiment, may be configured to maintain one or more user accounts and merchant accounts in an account database 188 on storage module 186, each of which may include account information associated with one or more individual users (e.g., user 102) and merchants. For example, the account information may include private financial information of user 102 and merchants (e.g., one or more merchants associated with merchant servers 190), such as one or more account numbers, passwords, credit card information, banking information, or other types of financial information, which may be used to facilitate financial transactions between user 102, and one or more merchants associated with merchant servers 190. The account information may also include personal information, such as one or more contact information (e.g., phone number, address, email, etc.) and other account identifications (IDs) of user 102 that are maintained by third parties (e.g., user names or account numbers). In various aspects, the methods and systems described herein may be modified to accommodate users and/or merchants that may or may not be associated with at least one existing user account and/or merchant account, respectively.

In one implementation, user 102 may have identity attributes stored with service provider server 180, and user 102 may have credentials to authenticate or verify identity with service provider server 180. User attributes may include personal information, banking information and/or funding source information. In various aspects, the user attributes may be passed to service provider server 180 as part of a login, search, selection, purchase, and/or payment request, and the user attributes may be utilized by service provider server 180 to associate user 102 with one or more particular user accounts maintained by service provider server 180.

One or more merchant servers 190, in various embodiments, may be maintained by one or more business entities that offer various items, such as goods and/or services, for purchase and payment (e.g., a discount retailer, a supermarket, a grocery store, a convenience store, a farmers market, a restaurant, a café, a merchandise store, a clothing store, a department store, an electronics store, or other merchant) or, in some cases, by a partner of a business entity that processes transactions on behalf of business entities. The business entities may maintain a merchant website through which the various items are offered for purchase and payment. In some embodiments, business entities may need registration of user identity information as part of offering items to user 102 over network 170. As such, each of one or more merchant servers 190 may include a merchant database on a storage module 196 for identifying available items, which may be made available, at least in part, to biometric system 110 and/or user device 150 for viewing and purchase by user 102. In one or more embodiments, user 102 may complete a transaction such as purchasing the items via service provider server 180.

Each of merchant servers 190, in one embodiment, may include a marketplace module 192, which may be configured to provide data or information to biometric system 110 and/or user device 150 over network 170. For example, marketplace module 192 may transmit item data or information to user device 150 to present the item data or information on user device 150. User 102 may interact with marketplace module 192 through user interface module 152 of user device 150 to search and view various items available for purchase in the merchant database on storage module 196.

Each of merchant servers 190, in one embodiment, may include at least one merchant identifier 194, which may be included as part of the one or more items made available for purchase so that, for example, particular items are associated with particular merchants. In one implementation, merchant identifier 194 may include one or more attributes and/or parameters related to the merchant, such as business and banking information. Merchant identifier 194 may include attributes related to merchant server 190, such as identification information (e.g., a serial number, a location address, GPS coordinates, a network identification number, etc.). In various embodiments, user 102 may conduct transactions (e.g., searching, selection, monitoring, purchasing, and/or providing payment for items) with each merchant server 190 via service provider server 180 over network 170.

A merchant website, in an embodiment, may be maintained by a merchant and communicate (e.g., using merchant server 190) with service provider server 180 over network 170. For example, the merchant website may communicate with service provider server 180 in the course of various services offered by service provider server 180 to the merchant website, such as payment intermediary between customers of the merchant website and the merchant website itself. The merchant website may use an application programming interface (API) that allows it to offer sale of goods in which customers are allowed to make payment through service provider server 180, while user 102 may have an account with service provider server 180 that allows user 102 to use service provider server 180 for making payments to merchants that allow use of authentication, authorization, and payment services of service provider server 180 as a payment intermediary. The merchant website may also have an account with service provider server 180.

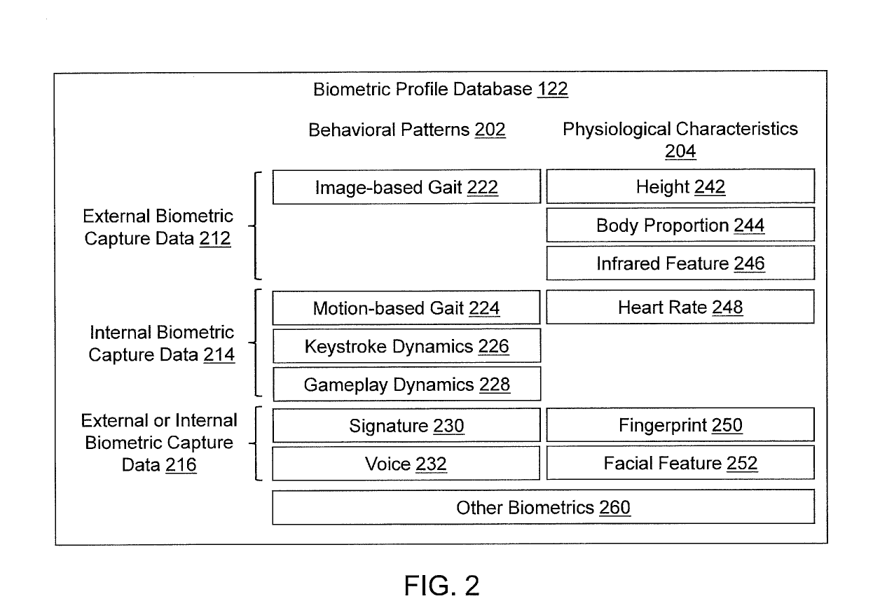

Referring now to FIG. 2, a block diagram for an exemplary biometric profile database 122 is described according to an embodiment of the present disclosure.

Biometric profile database 122 may include biometric profiles of users. Each biometric profile may be associated with a particular user (e.g., user 102) and may include biometric data of many types associated with the particular user, such as biometric data for behavioral patterns 202 and/or biometric data for physiological characteristics 204. The biometric data may be reference biometric data such that when biometric system 110 receives biometric data of user 102, the received biometric data may be compared with the reference biometric data of the same type. Each type of biometric data may be external biometric capture data 212 that is determined from biometric samples captured by external biometric capture device 130, internal biometric capture data 214 that is determined from biometric samples captured by user device 150, or internal and/or external biometric capture data 216 that is determined from biometric samples captured by external biometric capture device 130 and/or user device 150.

Behavioral pattern biometric data 202 based on biometric samples from external biometric capture device 130 may include, for example, image-based gait data 222. Image-based gait data 222 may be based on an image sequence that includes a visual representation of user 102 walking captured by camera 132 of external biometric capture device 130 while user 102 is walking.

Behavioral pattern biometric data 202 based on biometric samples from user device 150 may include, for example, motion-based gait data 224, keystroke dynamics data 226, and/or gameplay dynamics data 228. Motion-based gait data 224 may be based on motion measurements that include a representation of user 102 movement captured by motion sensors 158 of user device 150 while user 102 is walking. Keystroke dynamics data 226 may be based on keyboard logging by internal biometric capture module 164 using user interface module 152 of user device 150. Gameplay dynamics data 228 may be based on gameplay logging by internal biometric capture module 164 using user interface module 152 of user device 150.

Behavioral pattern biometric data 202 that may be based on biometric samples from external biometric capture device 130 and/or user device 150 may include, for example, signature data 230 and/or voice data 232. Signature data 230 may be based on a hand signature of user 102 captured on a touchscreen of external biometric capture device 130 and/or user device 150. Voice data 232 may be based on a voice recording that includes a representation of a voice of user 102 captured by a microphone of user device 150 and/or external biometric capture device 130.

Physiological characteristic biometric data 204 based on biometric samples from external biometric capture device 130 may include, for example, height data 242, body proportion data 244, and/or infrared feature data 246. Height data 242 and/or body proportion data 244 may be based on an image or image sequence that include a visual representation of user 102 captured by camera 132 of external biometric capture device 130. Infrared feature data 246 may be based on an infrared image or image sequence that includes a representation of thermal characteristics of user 102 captured by an infrared sensor of external biometric capture device 130.

Physiological characteristic biometric data 204 based on biometric samples from user device 150 may include, for example, heart rate data 248. Heart rate data 248 may be based on heart rate monitoring by vital sign sensor 160 of user device 150.

Physiological characteristic biometric data 204 that may be based on biometric samples from external biometric capture device 130 and/or user device 150 may include, for example, fingerprint data 250 and/or facial feature data 252. Fingerprint data 250 may be based on a scan of a fingerprint of user 102 captured by a fingerprint scanner of external biometric capture device 130 and/or user device 150. Facial feature data 252 may be based on an image or image sequence that includes a visual representation of a face of user 102 captured by a camera of external biometric capture device 130 and/or user device 150.

Biometric profile database 122 may include other biometric data 260, which may be for a behavioral pattern or physiological characteristic, such as biometric data for an interaction of user 102 with his or her environment, a repetitive action, a style of user 102, or other behavioral pattern or physiological characteristic. For example, biometric data may be graphic user interface interaction data, driving style data, etc.

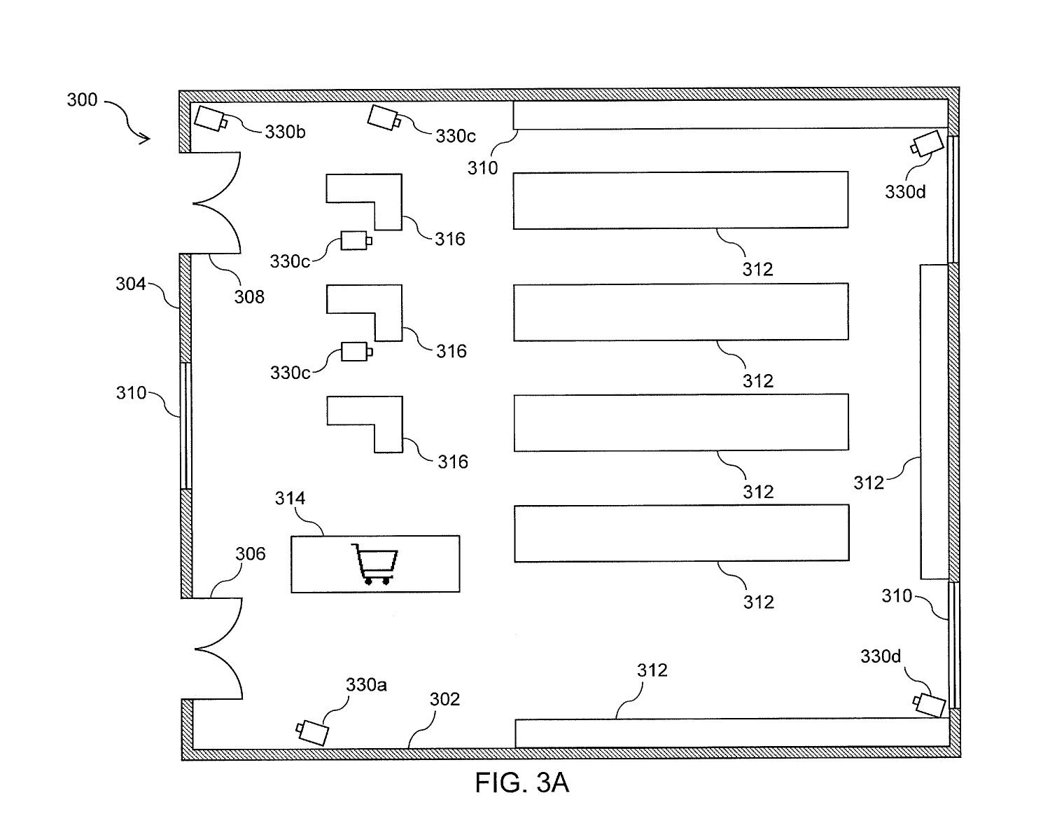

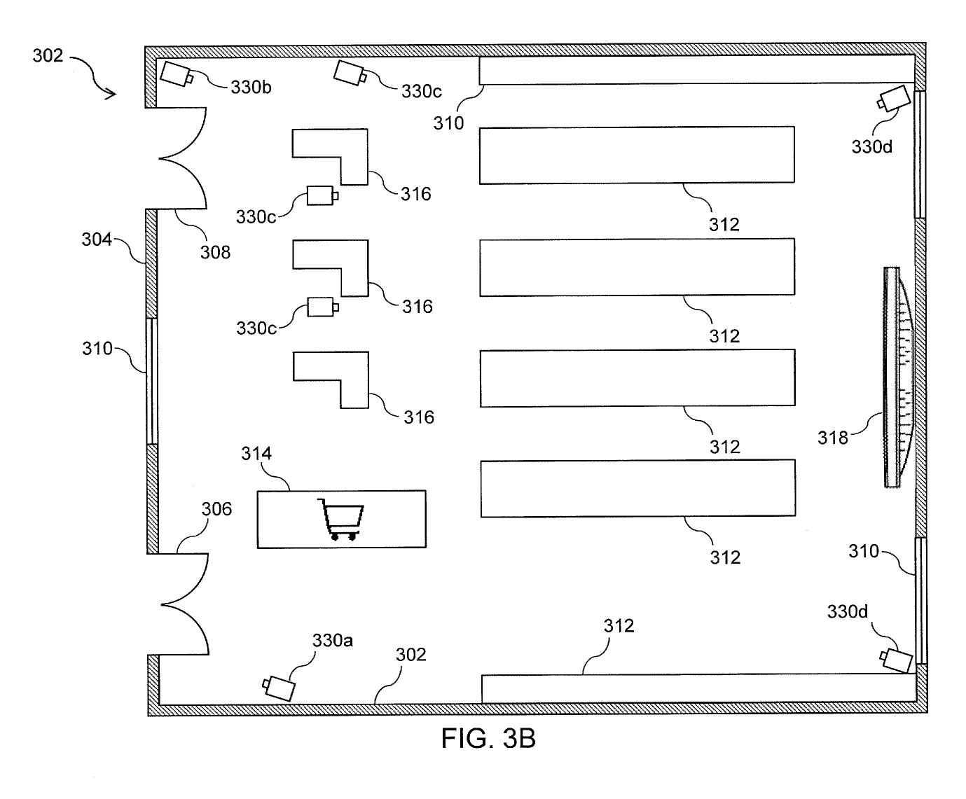

Referring now to FIG. 3A, a diagram of a top plan view of a physical merchant location 300 with external biometric capture devices 330a-d is illustrated according to an embodiment of the present disclosure. In an embodiment, merchant location 300 may include walls 304, an entrance 306, an exit 308, windows 310, item display area 312, which may include shelves, racks, refrigerators, and/or fridges for displaying items for purchase, a cart area 314 with carts, one or more POS 316, and one or more external biometric capture devices 330a-d. External biometric capture device 330a-d, which may be an implementation of external biometric capture device 130, may be placed at various places of merchant location 300.

In an embodiment, biometric capture device 330a located at entrance 306 may capture images and/or image sequences that include representations of user 102 while user 102 enters physical merchant location 300. Biometric system 110 may determine an identity and/or a characteristic of user 102 who enters the physical merchant location 300 based on biometric data determined using the images and/or image sequences captured by biometric capture device 330a at entrance 306. Biometric capture device 330b at exit 308 may capture images and/or image sequences that include representations of user 102 while the user 102 exits physical merchant location 300. Biometric system 110 may determine an identity and/or characteristic of user 102 who exits physical merchant location 300 based on biometric data determined using the images and/or image sequences captured by biometric capture device 330b at exit 308.

In an embodiment, one or more biometric capture devices 330c are located at a respective POS 306 and may capture images and/or image sequences that include representations of user 102 while user 102 is approaching respective POS 306 and/or when user is at respective POS 316. Biometric system 110 may identify user 102, authenticate user 102, and/or determine characteristics of user 102 based on biometric data determined using the images and/or image sequences captured by biometric capture device 330c at each POS 316.

Referring now to FIG. 3B, a diagram of a top plan view of a physical merchant location 302 with external biometric capture devices 330a-d and a display panel 318 is illustrated according to an embodiment of the present disclosure. In an embodiment, merchant location 302 may include walls 304, an entrance 306, an exit 308, windows 310, item display area 312, a cart area 314, one or more POS 316, display panel 318, and external biometric capture devices 330a-d.

In an embodiment, one or more biometric capture devices 330d are located in a vicinity of display panel 318. Biometric capture devices 330d may capture images and/or image sequences that include representations of one or more users 102 in a group. For example, the group may include one or more users 102 in the vicinity of display panel. Biometric system 110 may determine a group characteristic of users 102 in the group and/or identify users 102 in the group based on biometric data determined using the images and/or image sequences captured by biometric capture device 330d. The group characteristics may relate to, for example, gender, age, and/or emotional state. Biometric system 110 may display targeted advertisement on display panel 318 based on the determined group characteristics.

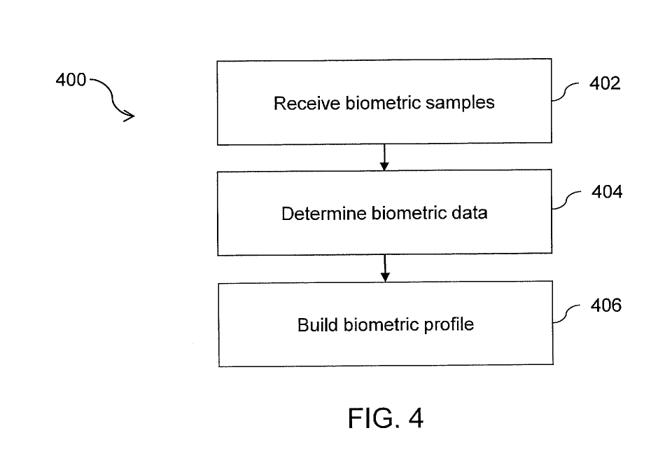

Referring now to FIG. 4, a flowchart 400 of a method for enrollment is illustrated according to an embodiment of the present disclosure.

At block 402, biometric system 110 receives a biometric sample from a biometric capture device, which may be external biometric capture device 130 and/or user device 150. In various embodiments, the biometric sample includes a representation of a behavioral pattern biometric of user 102. Behavioral pattern biometrics may include a gait, keystroke dynamics, gameplay dynamics, a signature, a voice, or other behavioral pattern biometrics. In further embodiments, the biometric samples include a representation of physiological characteristic biometrics of users 102. Physiological characteristic biometrics may include a height, a body proportion, an infrared feature, a heart rate, a fingerprint, a facial feature, or other physiological characteristic biometric.

In an embodiment, the biometric sample received from external biometric capture device 130 may be an image sample and/or an image sequence sample captured by a camera of external biometric capture device 130. The image sample or image sequence sample may include a representation of various biometrics, such as a gait, height, body proportion, infrared feature, or other biometrics. In another embodiment, biometric sample received from user device 150 may be a motion-based gait sample including a representation of gait, a keystroke dynamic sample including a representation of keystroke dynamics, a gameplay dynamic sample including a representation of gameplay dynamics, or a heart rate sample including a representation of a heart rate of user 102. In a further embodiment, biometric sample may be received from external biometric capture device 130 or user device 150 and may be a signature sample including a signature, a voice recording sample including a representation of a voice of user 102, a fingerprint sample including a scan of a fingerprint of user 102, or an image or image sequence sample including a representation of facial features of user 102.

At block 404, biometric system 110 determines biometric data from the biometric samples. In an embodiment, biometric system 110 (e.g., using biometric data determination module 112) determines biometric data of user 102 from the biometric sample in response to receiving the biometric sample. For example, biometric system 110 may extract features from the biometric sample and process the extracted feature data to generate biometric data, such as a biometric template.

At block 406, biometric system 110 builds biometric profiles of users. In an embodiment, biometric system 110 (e.g., using biometric profile module 114) builds biometric profiles by storing the biometric data as reference biometric data and associating the reference biometric data with a corresponding user 102 in biometric profile database 124 in storage module 122.

In an example, biometric system 110 may determine reference biometric data from a biometric sample captured by external biometric capture device 130 at a POS of a physical merchant location while user 102 approaches the POS. Biometric system 110 then determines an identity of user 102 based on user 102 providing information at the POS, such as by providing identification information (e.g., presenting a driver's license or other identification (ID)), swiping a credit or debit card, entering in a personal identification number, scanning a barcode presented on user device 150, and/or transmitting data from user device 150 to a merchant device using near field communications between user device 150 and the merchant device. Biometric system 110 may associate the reference biometric data with user 102 in response to identifying user 102.

Referring now to FIG, 5, a flowchart 500 of a method for identifying users based on biometrics is illustrated according to an embodiment of the present disclosure.

At block 502, biometric system 110 receives a biometric sample, as described at block 402 in FIG. 4.

At block 504, biometric system 110 determines biometric data from the received biometric sample, as described at block 404 in FIG. 4.

At block 506, biometric system 110 compares the biometric data with at least a part of reference biometric data. In an embodiment, biometric data may include one or more types of biometric data (e.g., one or more of gait biometric data, height biometric data, facial feature biometric data, etc.), Biometric system 110 (e.g., using comparison module 116) may determine the one or more types for the biometric data and, for each determined type of biometric data, search the biometric profiles associated with a plurality of users for reference biometric data of a relevant type (e.g., the same type). Biometric system 110 may compare the biometric data of each type with the reference biometric data of the relevant type, which may be a part of the reference biometric data included in the biometric profiles.

At block 508, biometric system 110 identifies and authenticates user 102. In various embodiments, biometric system 110 (e.g., using authentication module 118) may identify user 102 as one of the plurality of users associated with respective biometric profiles based on comparing the biometric data with reference biometric data, For example, biometric system 110 may determine a matching score for each comparison and identify user 102 as one of the plurality of users based on determining one of the matching scores being above a predetermined threshold.

In some embodiments, biometric system 110 (e.g., using authentication module 118) may authenticate user 102 based on identifying user 102. In other embodiments, biometric system 110 (e.g., using authentication module 118) may authenticate user 102 based on user 102 providing information (e.g., at a POS). User 102 may be required to provide less information than when user 102 is not identified by biometric system. For example, when user 102 is not identified by biometric system 110, user 102 may be required to swipe a debit card and enter a PIN, or swipe a credit card and provide a signature. When user 102 is identified by biometric system 110, user 102 may enter a PIN without swiping a debit card, or provide a signature without swiping a credit card. Biometric system 110 may authorize user 102 to make purchases for a predetermined time period in response to authenticating the user.

In an embodiment, biometric system 110 may identify user 102 using one type of biometric data (e.g., facial feature data). In other embodiments, biometric system 110 may identify user 102 using two or more types of biometric data (e.g., a combination of facial recognition, gait, and height). One or more types of biometric data may on its own be capable of identifying user 102 (e.g., facial feature data). One or more types of biometric data (e.g., gait data, height data, etc.) may identify user 102 only in combination with other biometric data. For example, height data of user 102 may not identify user 102 because there are many users who are of similar height, but biometric system 110 may use height data of user 102 (e.g., 5 feet 8 inches) to determine a reference set (e.g., a set of users who are between 5 feet 7 inches and 5 feet 9 inches) in which height data of user 102 belongs to help identify user 102.

At block 510, biometric system 110 or service provider server 180 processes payment. Payment processing module 184 may be included in biometric system 110 or service provider server 180. In an embodiment, biometric system 110 or service provider server 180 (e.g., using payment processing module 184) receives a payment request for a purchase from merchant server 190. The payment request may be associated with the biometric data. Biometric system 110 or service provider server 180 may determine account information associated with user 102, and process the payment request. For example, account information associated with user 102 may be determined based on an association between biometric profile of user 102 and account information of user 102 stored in a storage module (e.g., storage module 122 or 186).

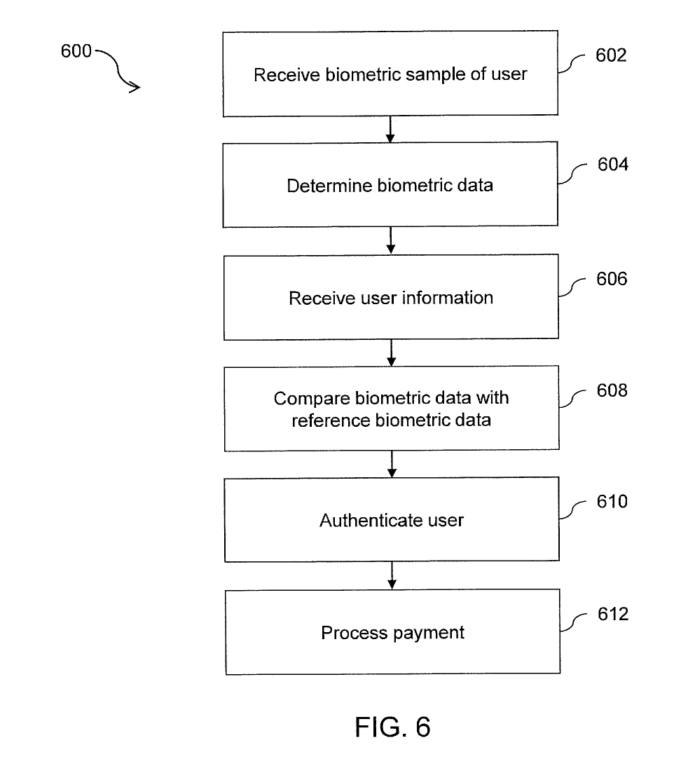

Referring now to FIG. 6, a flowchart 600 of a method for authenticating users based on biometrics is illustrated according to an embodiment of the present disclosure.

At block 602, biometric system 110 receives a biometric sample for user 102, as described at block 402 in FIG. 4. For example, external biometric capture device 130 at a POS of a physical merchant location may capture biometric samples while user 102 approaches the POS or when user 102 is at the POS. In another example, user device 150 captures biometric samples for keyboard dynamics and/or gameplay dynamics.

At block 604, biometric system 110 determines biometric data from the received biometric sample, as described at block 404 in FIG. 4.

At block 606, biometric system 110 receives user information. In an embodiment, biometric system 110 (e.g., using authentication module 118) receives user information received from merchant server 190 including, for example, a user-entered personal identification number (PIN), card information based on reading of a credit or debit card, a signature, barcode information based on scanning of a barcode, and/or user identifier information based on near field communications between user device 150 and a merchant device. In another embodiment, biometric system 110 (e.g., using authentication module 118) receives user information from user device 150 that includes login information, such as a user ID and a password that user 102 enters on user device 150. Based on the received user information, biometric system 110 identifies user 102.

At block 608, biometric system 110 compares the biometric data with at least a part of reference biometric data. In an embodiment, biometric system 110 (e.g., using comparison module 116) may access a biometric profile associated with user 102 identified using user information at block 606. Biometric system 110 may determine one or more types for the biometric data and, for each determined type of biometric data, search the biometric profile associated with user 102 for reference biometric data of a relevant type (e.g., the same type). Biometric system 110 may compare the biometric data of each type with reference biometric data of the relevant type, which may be a part of the reference biometric data included in the biometric profile. For example, biometric system 110 may determine a matching score for the comparison and authenticate user 102 based on determining the matching scores being above a predetermined threshold.

At block 610, biometric system 110 authenticates user 102. In an embodiment, biometric system 110 (e.g., using authentication module 118) may authenticate user 102 based, at least in part, on the comparison of the biometric data with the reference biometric data. In other embodiments, biometric system 110 may authenticate user based on both the comparison of the biometric data with reference biometric data and the user information. Biometric system 110 may authorize user 102 to make purchases for a predetermined time period in response to authenticating the user.

In an embodiment, if user information associated with user 102 (e.g., card information based on a swiping of a credit card) is received but the captured biometric data does not match the reference biometric data associated with user 102, biometric system 110 may deny authentication. Accordingly, biometric system 110 advantageously provides improved security for authentication. If an unauthorized user tries to make a purchase using a credit card or a user device 150 of another person, biometric system 110 will deny authenticating the unauthorized user. Thus, unauthorized users are prevented from using stolen credit cards and user devices 150.

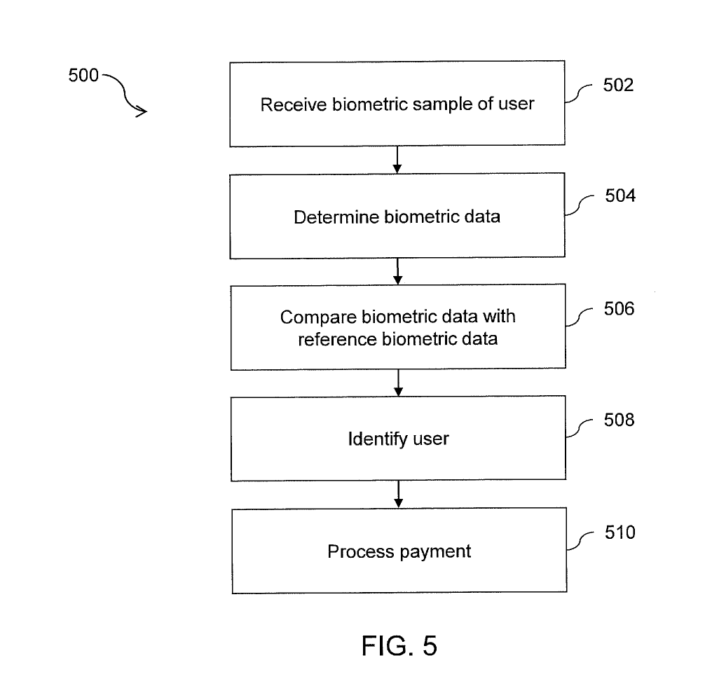

At block 612, biometric system 110 processes payment, as described at block 510 of FIG. 5.

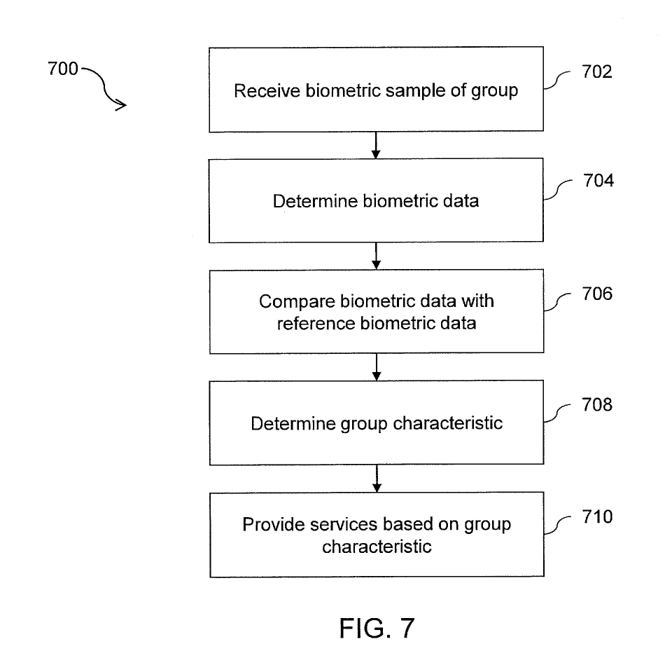

Referring now to FIG. 7, a flowchart 700 of a method for determining group characteristics based on biometrics is illustrated according to an embodiment of the present disclosure.

At block 702, biometric system 110 receives a biometric sample for users 102 in a group from a biometric capture device, which may be external biometric capture device 130 and/or user device 150. In an example, referring to FIG. 3, external capture device 330d located at or near display panel 312, may capture an image or image sequence sample that includes a representation of users in a group. The group may be users within capture range of the external biometric capture device 330d.

At block 704, biometric system 110 determines biometric data from the received biometric sample. In an embodiment, biometric system 110 (e.g., using biometric data determination module) determines biometric data of users 102 in the group from the biometric sample in response to receiving the biometric sample from the biometric capture device.

At block 706, biometric system 110 compares the biometric data with reference biometric data for each user 102. Biometric system 110 (e.g., using comparison module 116) may determine the one or more types for the biometric data and, for each determined type of biometric data, compare the biometric data of each type with reference biometric data of the relevant type.

At block 708, biometric system 110 determines one or more group characteristics. In various embodiments, the group characteristics may relate to gender, age, emotional state, or other group characteristics. For example, the group characteristics may include a gender distribution of the group, age distribution of the group, and/or an emotional state distribution of the group. The reference biometric data may be arranged into a plurality of reference data sets for the group characteristics. For example, a female reference data set may include reference data associated with females, and a male reference data set may include reference data associated with males. Biometric system 110 may determine that the biometric data of an individual user 102 of the group belongs to a reference data set for certain group characteristic.

At block 710, biometric system 110 provides services based on the one or more group characteristics. Service module 182 may be included in biometric system 110 or service provider server 180. In an embodiment, biometric system 110 or service provider server 180 (e.g., using service module 182) may determine a service to provide, such as information, entertainment, a targeted advertisement, a notification, a discount or a deal, etc., based on the group characteristics.

In an example, referring to FIG. 3, in response to receiving the captured image or image sequence from external capture device 330 and sampling and determining group characteristics, biometric system 110 or service provider server 180 may select an advertisement to present on display panel 312 based on the group characteristics (e.g., present advertisements relevant to women if there are more women than men in the group, present advertisements relevant to children if there are children in the group, etc.).

In another example, biometric system 110 or service provider server 180 may provide a notification to relevant authorities (e.g., police, law enforcement, security at physical merchant location, etc.) in response to the group characteristics indicating violence or a high level of stress. The notification may include information regarding the group characteristics and the location of the group of users.

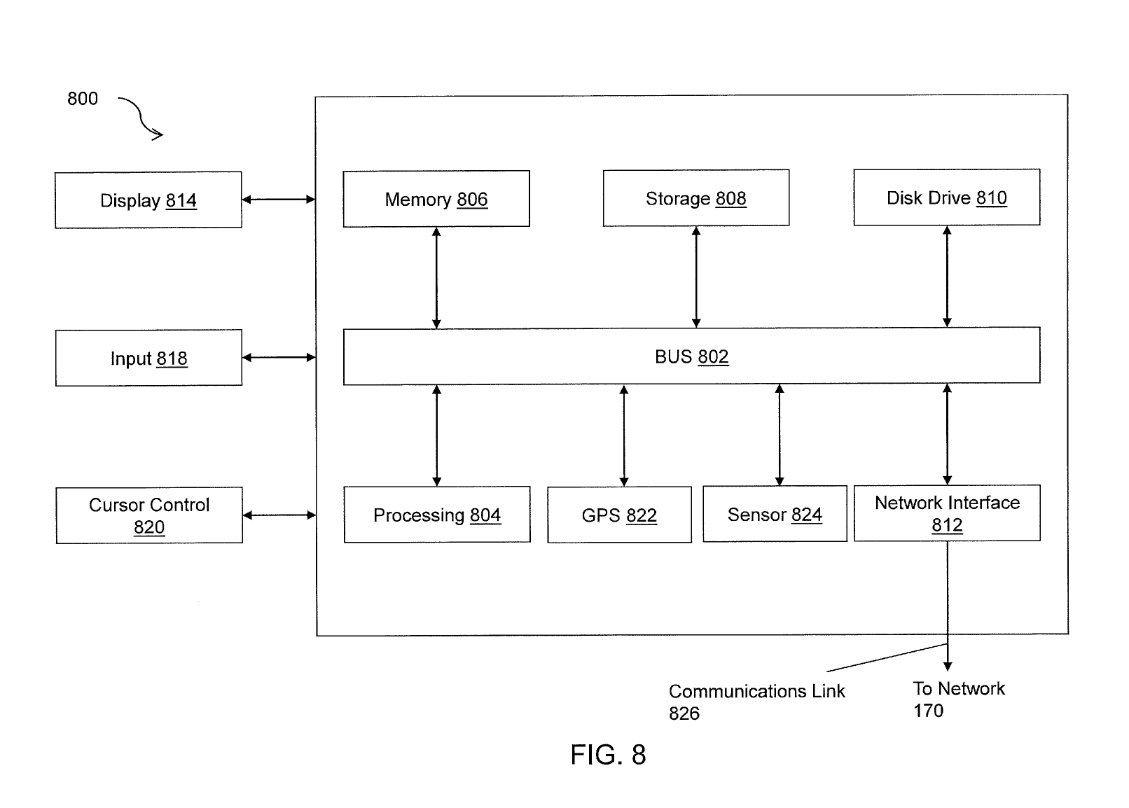

Referring now to FIG. 8, an embodiment of a computer system 800 suitable for implementing, for example, the biometric system, external biometric capture device, user device, service provider server, and merchant server is illustrated. It should be appreciated that other devices utilized by users, service providers, and/or merchants in the system discussed above may be implemented as computer system 800 in a manner as follows.

In accordance with various embodiments of the present disclosure, computer system 800, such as a computer and/or a network server, includes a bus 802 or other communication mechanism for communicating information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic or optical), a network interface component 812 (e.g., modem or Ethernet card), a display component 814 (e.g., light-emitting diode (LED) display component, organic light-emitting diode (OLED) component, liquid-crystal (LCD) display component, plasma display panel (PDP), cathode ray tube (CRT) display component, or other display component), an input component 818 (e.g., keyboard, keypad, virtual keyboard, touchscreen, etc.), a cursor control component 820 (e.g., mouse, pointer, trackball, etc.), a location determination component 822 (e.g., a Global Positioning System (GPS) device as illustrated, a cell tower triangulation device, and/or a variety of other location determination devices known in the art), and/or a sensor component 824. In one implementation, disk drive component 810 may include a database having one or more disk drive components.

In accordance with various embodiments of the present disclosure, computer system 800 performs specific operations by processor 804 executing one or more sequences of instructions contained in memory component 806, such as described herein with respect to the biometric system, user device, service provider server, and merchant server. Such instructions may be read into system memory component 806 from another computer readable medium, such as static storage component 808 or disk drive component 810. In other embodiments, hard-wired circuitry may be used in place of, or in combination with, software instructions to implement the present disclosure.

Logic may be encoded in a computer readable medium, which may refer to any medium that participates in providing instructions to processor 804 for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component 810, volatile media includes dynamic memory, such as system memory component 806, and transmission media includes coaxial cables, copper wire, and fiber optics, including wires that comprise bus 802. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 800. In various other embodiments of the present disclosure, a plurality of computer systems 800 coupled by a communication link 826 to the network 170 (e.g., such as a LAN, WLAN, PTSN, and/or various other wired or wireless networks, including telecommunications, mobile, and cellular phone networks) may perform instruction sequences to practice the present disclosure in coordination with one another.

Computer system 800 may transmit and receive messages, data, information and instructions, including one or more programs (i.e., application code) through communication link 826 and network interface component 812. Network interface component 812 may include an antenna, either separate or integrated, to enable transmission and reception via communication link 826. Received program code may be executed by processor 804 as received and/or stored in disk drive component 810 or some other non-volatile storage component for execution.

In view of the present disclosure, it will be appreciated that various devices, systems, and methods have been described according to one or more embodiments for authentication and characterizing groups based on biometrics.

Although various components and steps have been described herein as being associated with biometric system 110, one or more external biometric capture device 130, one or more user devices 150, service provider server 180, and/or merchant server 190 of FIG. 1, it is contemplated that the various aspects of such devices and servers illustrated in FIG. 1 may be distributed among a plurality of servers, devices, and/or other entities.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, mobile device, server, and other devices described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a storage module configured to store biometric profiles of users that include reference biometric data, the reference biometric data including data for one or more types of behavioral patterns;
a biometric data determination module configured to determine biometric data of a user from a biometric sample in response to receiving the biometric sample from a biometric capture device configured to capture the biometric sample;
a comparison module configured to compare the biometric data with at least one of the reference biometric data;
an authentication module configured to authenticate the user based, at least in part, on the comparison; and
a payment processor module configured to receive a payment request for a purchase and process the payment request in response to authenticating the user.

2. The system of claim 1, wherein the biometric data determination module is configured to determine the reference biometric data in response to receiving biometric samples from biometric capture devices, the system further comprising a biometric profile module configured to build the biometric profiles by associating the reference biometric data with the users in the storage module.

3. The system of claim 1, wherein the reference biometric data further includes data for one or more types of physiological characteristics.

4. The system of claim 3, wherein the reference biometric data for the one or more types of behavioral patterns include gait data, typing dynamics data, gameplay dynamics data, signature data, and/or voice data, and wherein the reference biometric data for the one or more types of physiological characteristics include height data, facial feature data, body proportion data, and/or heartbeat data.

5. The system of claim 4, wherein the gait data comprise a plurality of types including gait data for walking, walking while pushing a shopping cart, walking with a shopping basket, walking while wearing certain shoes, jogging, and/or running.

6. The system of claim 3, wherein the biometric capture device is located at a point of sale of a physical merchant location, wherein the biometric capture device is configured to capture an image sequence sample while the user is approaching the point-of-sale, and wherein the biometric data determination module is configured to determine height data, image-based gait data, and facial feature data of the approaching user from the image sequence sample.

7. The system of claim 6, wherein the authentication module is configured to authenticate the user further based on authentication data received from a merchant device at the point of sale, the authentication data including a user-entered personal identification number (PIN), a reading of a credit or debit card, a signature, a scanning of a barcode, and/or a near field communication between a user device and a merchant device.

8. The system of claim 1, wherein the biometric capture device is a user device configured to capture a keystroke dynamic sample or a gameplay dynamics sample using a user interface of the user device and transmit the keystroke dynamic sample or a gameplay dynamics sample to the biometric system.

9. The system of claim 1, wherein the comparison module is configured to compare the biometric data with the reference biometric data to generate a matching score, determine a reference data set in which the biometric data belongs, or both, and wherein the authentication module authorizes purchases by the user for a predetermined time period in response to authenticating the user.

10. A biometric system comprising:
a storage module configured to store reference biometric data of a plurality of types;
a biometric data determination module configured to determine biometric data of one or more users in a group from a biometric sample in response to receiving the biometric sample from a biometric capture device configured to capture the biometric sample;
a comparison module configured to compare the biometric data with at least one of the reference biometric data; and
a service module configured to determine one or more group characteristics based on the comparison and provide services based on at least of the one or more group characteristics.

11. The system of claim 10, wherein the one or more group characteristics relate to gender, age, and/or emotional state.

12. The system of claim 10, wherein the biometric capture device is located at a physical merchant location, and wherein service module is further configured to select an advertisement to display on a display panel based on the one or more group characteristics.

13. The system of claim 10, wherein the service module is configured to transmit a notification in response to the one or more group characteristics indicating violence or a high level of stress.

14. A method, comprising:
determining, by a processing system in response to receiving biometric samples from biometric capture devices, reference biometric data, the reference biometric data including data for one or more types of behavioral patterns;
building, by the processing system associating the reference biometric data with the users in a non-transitory hardware memory, biometric profiles of users;
determining, by the processing system in response to receiving a further biometric sample, biometric data of a user;
comparing, by the processing system, the biometric data with at least one of the reference biometric data;
authenticating, by the processing system, the user based, at least in part, on the comparing; and
processing, by the processing system, a payment request for a purchase in response to receiving the payment request and the authenticating.

15. The method of claim 14, wherein the reference biometric data further includes data for one or more types of physiological characteristics.

16. The method of claim 15, wherein the reference biometric data for the one or more types of behavioral patterns include gait data, typing dynamics data, gameplay dynamics data, signature data, and/or voice data, and wherein the reference biometric data for the one or more types of physiological characteristics include height data, facial feature data, body proportion data, and/or heartbeat data; and wherein the gait data comprise a plurality of types including gait data for walking, walking with a shopping cart, walking with a shopping basket, jogging, and/or running.

17. The method of claim 15, wherein the biometric capture device is located at a point of sale of a physical merchant location, wherein the biometric samples and the further biometric sample include image sequence samples while the user is approaching the point-of-sale, and wherein the reference biometric data and the biometric data include height data, image-based gait data, and facial feature data.

18. The method of claim 17, wherein the authenticating is further based on authentication data received from a merchant device at the point of sale, the authentication data including a user-entered personal identification number (PIN), a reading of a credit or debit card, a signature, a scanning of a barcode, and/or a near field communication between a user device and a merchant device.

19. The method of claim 17, wherein the building comprises associating the corresponding reference biometric data with the user in response to identifying the user at the point of sale based on a user-entered personal identification number (PIN), a reading of a credit or debit card, a scanning of a barcode, and/or a near field communication between a user device and a merchant device.

20. The method of claim 14, wherein the biometric capture device is a user device configured to capture a keystroke dynamic sample, a gameplay dynamics sample, a motion-based gait sample, and/or a heart rate sample.
